(19) United States
(12) Patent Application Publication
(10) Pub. No.: US 2013/0311227 A1
(43) Pub. Date: Nov. 21, 2013

(54) RESOURCE PLANNING USING FULL TIME EQUIVALENTS

(71) Applicants: Cipriano A. Santos, Modesto, CA (US); Maria T. Gonzalez Diaz, Mountain View, CA (US); Alex Xin Zhang, San Jose, CA (US); Cynthia L. Glovinsky, Huron, OH (US)

(72) Inventors: Cipriano A. Santos, Modesto, CA (US); Maria T. Gonzalez Diaz, Mountain View, CA (US); Alex Xin Zhang, San Jose, CA (US); Cynthia L. Glovinsky, Huron, OH (US)

(21) Appl. No.: 13/983,049

(22) PCT Filed: Mar. 11, 2011
(86) PCT No.: PCT/US11/28151

§ 371 Date: Jul. 31, 2013

(51) Int. Cl. G06Q 10/06

(52) U.S. Cl. CPC G06Q 10/06313
USPC 705/7.23

(57) ABSTRACT

Methods, apparatus, and computer readable media with executable instructions stored thereon for resource planning using FTEs are provided. Example methods of the present disclosure can include identifying full time equivalent (FTE) requirements of jobs, skills corresponding to the jobs, resources corresponding to the skills, and FTE capacity of resources [572]. Qualified resources are determined, by a computer, with respect to each job based on the corresponding skills of the resources relative to the skills corresponding to the jobs [574]. FTE capacity of qualified resources is allocated, by a computer, to jobs in a manner that maximizes FTE requirements of jobs having resources allocated thereto, such that a qualified resource is allocated to a job at most to the lesser of the FTE requirement of the job or the FTE capacity of the resource [576].

### BACKGROUND

Organizations can employ and/or manage large numbers of resources, which may be geographically dispersed. Resources may be people, equipment, and/or services, etc. Resource planning attempts to assign applicable resources to organizational needs in an efficient and cost effective manner. Resource planning can be a dynamic, on-going process since organizational needs and available resources can grow, shrink, and/or change with time. For example, an organization may require more resources as it begins a new project or business venture, or different resources as a project progresses.

One particular problem arising in resource planning is to provide a qualified resource to the right job at the right time at an appropriate cost. Providing a resource with the right qualifications may entail providing necessary equipment to a project or task, and/or identifying a qualified candidate for a particular job. Assigning an over-qualified resource to a job can increase the cost of accomplishing the job if the resource cost is more than other resources capable of accomplishing the job. Assigning an under-qualified resource to a job can also result in increased cost if the resource isn't able to accomplish the job, or do so in a timely manner, which can cause inefficiencies in a coordinated process. Leaving a job unfilled can likewise cost the organization due to impact to project completion, inefficiencies, and/or penalties that may be incurred.

In a previous approach to resource planning, a quantity of jobs (e.g., positions) were expressed in terms of headcount. Headcount refers to a quantity of (whole) people dedicated to a particular activity, such as a business organization, project, etc., during the time period of the activity. For example, a project may require a manager, three engineers, and an accountant, for a headcount of four people. Headcount infers full time attention of the resource to an assignment. However, headcount can translate into different quantities of man-hour efforts since work schedules and holidays can vary geographically.

### BRIEF DESCRIPTION OF THE DRAWINGS

FIG. 1 illustrates a resource planning method using full time equivalents according to the present disclosure.

FIG. 2 illustrates an example resource planning system using full time equivalents according to the present disclosure.

FIG. 3 illustrates a block diagram of an example of a computing system for resource planning using full time equivalents according to the present disclosure.

FIG. 4 illustrates a block diagram of an example of a computer readable medium (CRM) in communication with processing resources according to the present disclosure.

FIG. 5 is a flow chart illustrating an example of a method for resource planning using full time equivalents according to the present disclosure.

### DETAILED DESCRIPTION

Methods, apparatus, and computer readable media with executable instructions stored thereon for resource planning using FTEs are provided. Example methods of the present disclosure can include identifying full time equivalent (FTE) requirements of jobs, skills corresponding to the jobs, resources corresponding to the skills, and FTE capacity of resources. Qualified resources are determined, by a computer, with respect to each job based on the corresponding skills of the resources relative to the skills corresponding to the jabs. FTE capacity of qualified resources is allocated, by a computer, to jobs in a manner that maximizes FTE requirements of jobs having resources allocated thereto, such that a qualified resource is allocated to a job at most to the lesser of the FTE requirement of the job or the FTE capacity of the resource.

As used herein, a Full Time Equivalent (FTE) refers to a certain portion of full time assignment according to the customs in the geographic location of the resource. For example, in some locations the workweek may be defined as having 40 hours per week, while in other locations the workweek may be defined as having 37 hours per week. An FTE of 1 indicates a full time resource, however that is locally defined at the location of the resource. An FTE of 0.5 indicates half of a full time resource (needed or provided).

As used herein, an organization may be a business entity, but need not be limited to an entity having a commercial intent. As used herein, resources may refer to human and non-human resources, such as people, equipment, buildings, vehicles, services, assets, and the like. For example, resources may include employees, computer processing capability at a particular time or over some period of time, data storage hardware, and/or office space used by an organization, among others. As such, resource planning can include workforce planning. While example implementations of the present disclosure are provided herein in the context of human resource staffing, example implementations of the present disclosure are not so limited. The reader will appreciate that the methods and systems of the present disclosure can be applied to other resource planning scenarios, such as those involving non-human resources as well, as long as there are resource attributes for compliance.

As used herein, a job includes any function to which a resource can be assigned. For example, a job can be an employment situation, such as a professional services position that may be associated with a business entity or project associated with the business entity. A job can also be a task performed by an apparatus. For example, a job can be data storage performed by a storage device (e.g., memory), or a job can be a batch processing performed by one or more processors.

An organization, such as a business entity, can deliver a wide variety of products and/or services to customers. In order to operate most efficiently the organization strives to utilize resources with the right qualifications for the right job at the right time and for an appropriate cost. To that end, workforce planning is used by an organization to maximize utilization of its workforce, minimize overall labor cost, and properly match job requirements with employee qualifications so as to successfully accomplish the job with consideration for employee morale.

One aspect of workforce planning attempts to identify current and future gaps between the resources (e.g., workforce) available and the resources needed to provide the products and/or services of the organization. Workforce needs may be compartmentalized by sub-organizational divisions, such as departments, geographic locations, projects, etc. Workforce gap analysis can involve determining labor shortages (gaps) in desired skills and/or requisite experience, and over supply (gluts) of other skills and/or experience. Over supply of skills and/or experience can be a major cause of low utilization of labor within an organization. Labor shortages in certain skills and/or skill level can cause “emergency” sub-contracting, with associated higher third party labor procurement costs, delayed project delivery, lower quality due to rushed time lines, financial penalty for late delivery of products and/or services, and/or lower customer satisfaction, which can lead to lost business and revenue.

Example implementations of the present disclosure optimize the matching of job (e.g., position) skill requirements with resources (e.g., employees) where each is specified in full time equivalents (FTEs). Additionally, some example implementations of the present disclosure optimize the matching of job (e.g., position) skill requirements with resources (e.g., employees) over multiple time periods of a planning horizon based in part on a constancy constraint such that matching favors a particular FTE capacity of a qualified resource being allocated to a same particular FTE requirement of a job over multiple time periods. Previous approaches of assigning people to jobs have not been refined enough to handle FTE increments of jobs and/or resources, and have not expressly addressed constancy constraints in an automatic process. Therefore, one disadvantage of previous approaches is that the previous approaches are not capable of working with fractional portions of a job and/or resource, such as evaluating the possibility of assigning multiple resources towards satisfying a single job requirement, and evaluating the possibility of assigning a fractional portion of a resource to each of multiple job requirements, for example. Another disadvantage of previous approaches is that the previous approaches do not seek to maintain a particular resource assignment to a particular job requirement over multiple time periods.

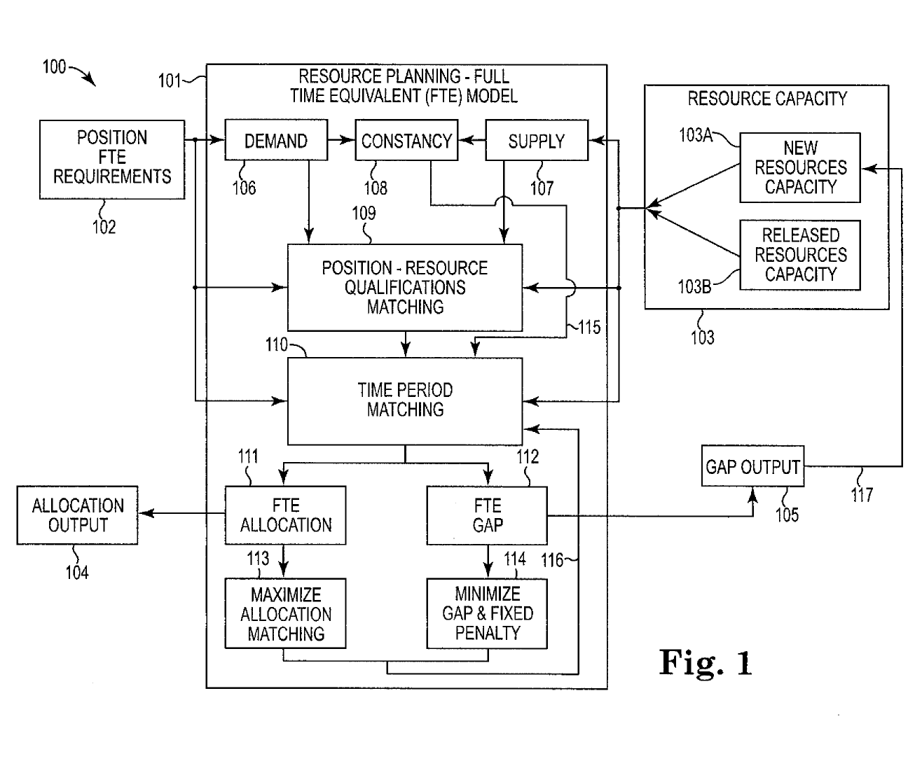

FIG. 1 illustrates a resource planning method 100 using full time equivalents according to the present disclosure. FIG. 1 provides a functional architecture of a resource planning model 101 that uses full time equivalents (hereinafter “RP-FTE model”). Inputs to the RP-FTE model 101 include position FTE requirements 102 and resource capacity 103. For example, the position FTE requirements 102 can be a database (e.g., table) of position FTE requirements, such as position identifiers, skill(s) required, skill level(s) required, project associations, time period association, etc., that describe positions to be filled in one or more time periods over a planning horizon.

The resource capacity 103 can be a database (e.g., table) of available resources corresponding to the one or more periods over a planning horizon, including new resource capacity 103A and released resource capacity 103B. Released resource capacity 103B refers to resources being freed-up from other projects as they end (e.g., existing employees). New resource capacity 103A refers to newly acquired resources (e.g., hired from outside an organization). Resource capacity 103 can include information describing an FTE capacity of various resources available one or more periods over the planning horizon. For example, a table can describe availability and qualification of resources that can be used to fill the requirements of position(s) within the planning horizon.

The RP-FTE model 101 is configured to define a resource-position matching score indicative of quality of a particular match. For example, a score of 1 can mean a resource is 100% qualified for a particular position. The RP-FTE model 101 can be implemented by a Mixed Integer Programming (MIP) mathematical model that maximizes a total matching score by maximizing fulfillment of position FTE requirements while considering resources capabilities, capacity, and availability. Alternatively, the RP-FTE model 101 can be implemented to optimize a total matching score by optimizing fulfillment of position FTE requirements, for example, where a unique maximum cannot be achieved. Optimizing can include maximum and near-maximum values, and will be appreciated as intending to obtain an efficient solution, such as a solution that exceeds a pre-defined threshold of performance.

According to one or more example implementations of the present disclosure, an RP-FTE model 101 implemented as an MIP mathematical model can also attempt to maintain constancy of a resource allocation to fill a similar position over more than one time periods of a planning horizon. Constancy refers to allocating a same resource to a particular project position over multiple time periods of the planning horizon. Constancy can be achieved if a particular resource capacity is greater than or equal to the position FTE requirement at each of multiple periods of time of a planning horizon such that the same particular resource can be used to fill the position FTE requirement over the multiple time periods of the planning horizon.

The outputs of the RP-FTE model 101 can include an allocation output 104 and a gap output 105. The allocation output 104 can be, for example, a listing (e.g., table) indicating a resources FTE Allocation Plan providing resource-position matches on an FTE basis. The Allocation Plan details the FTE capacity of a resource allocated to fill a position at each period over the planning horizon. The gap output 105 can be, for example, a listing (e.g., table) indicating an FTE Gap Plan. The Gap Plan determines FTE requirement of a position that could NOT be filled (e.g., by presently available resources—new and released) at each period over the planning horizon.

FIG. 1 shows position FTE requirements 102 are input to the RP-FTE model 101 and applied to evaluate a demand constraint 106. Resource capacity 103 is input to the RP-FTE model 101 and applied to evaluate a supply constraint 107. Each of the demand constraint 106 and supply constraint 107 evaluations can be further utilized in evaluating a constancy 108 constraint, as discussed in more detail below. As shown, position FTE requirements 102 and resource capacity 103 are also provided as inputs to a position-resource qualifications matching process 109. The position-resource qualifications matching process 109 determines a quality of matching of a resource with respect to one or more available positions.

Position FTE requirements 102, resource capacity 103, demand constraint 106, supply constraint 107, constancy constraint 108, and an output from the position-resource qualifications matching process 109 are used as inputs to a time period matching process 110. The time period matching process 110 matches resources and positions within one or more time periods of a planning horizon. Outputs of the time period matching process 110 include FTE allocation information 111 and FTE gap information 112. For example, FTE allocation information 111 and FTE gap information 112 can be determined for a particular iteration of resource and position matching. The FTE allocation information 111 can be used in logic configured to maximize allocation matching 113. The FTE gap information 112 can be used in logic configured to minimize gap and fixed penalty 114. Outputs from the FTE allocation information 111 and FTE gap information 112 logic can be used iteratively in iterations of the time period matching 110, as indicated by feedback 116.

As a solution of the RP-FTE model 101 converges, the FTE allocation information 111 can be output as the allocation output 104, and the FTE gap information 112 can be output as the gap output 105. However, example implementations of the present disclosure are not so limited, and allocation output 104 and gap output 105 can include intermediate results (e.g., prior to solution convergence beyond a preset convergence criteria). As shown in FIG. 1 at feedback 117 the FTE Gap Plan can be used in determining the new resource capacity needed (e.g., to fill those positions that could NOT be filled by presently available, new and released, resources).

As mentioned above, an RP-FTE model 101 can be implemented as an MIP mathematical model. The following sets and indices can be utilized by RP-FTE model 101 with respect to projects, jobs (e.g., positions), skills, resources (e.g., employees), and time periods:

wεW: Index and set of resources

jεJ: Index and set of jobs

iεI: Index and set of projects (e.g., opportunity)

jiεJI: Index for positions within projects

tεT: Index and set of time periods (e.g., working weeks in planning horizon)

According to various example implementations, the RP-FTE model 101 implemented as an MIP mathematical model can utilize the following input parameters, which serve to specify the requirements associated with a job (e.g., skill(s), qualifications and availability of a resource during certain periods, project priority, and costs associated with an allocation of a resource and a penalty for not filling a particular job. A job skill is a skill required by a job. A resource skill is a skill provided by a resource. A combination of a job j of project i can be referred to as a position ji. A resource can be a particular employee, for example.

REQ_{j,i,t}: requirements for job j of project i during period t, as FTE

ΔK_{w,t}: capacity of resource w at beginning of period t, as FTE

Q_{w,ji}=1 if resource w is qualified for position ji, =0 otherwise.

ppᵢ: Priority of project i

RLⱼᵢ: Revenue loss of position ji

MS_{w,j,i}: Matching score of resource w for position ji.

CU_{w,j,i}: Allocation of fixed cost of resource w to position ji.

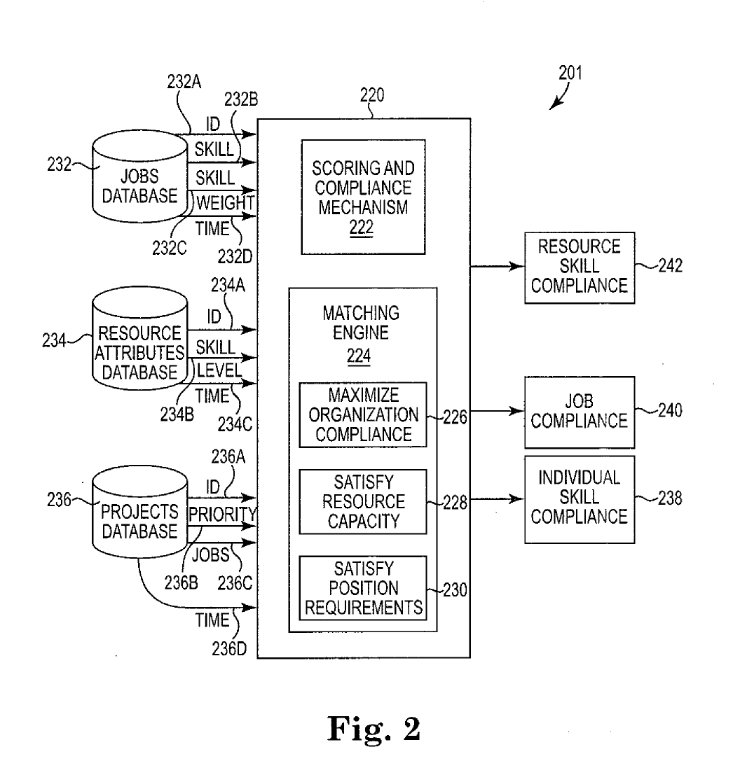

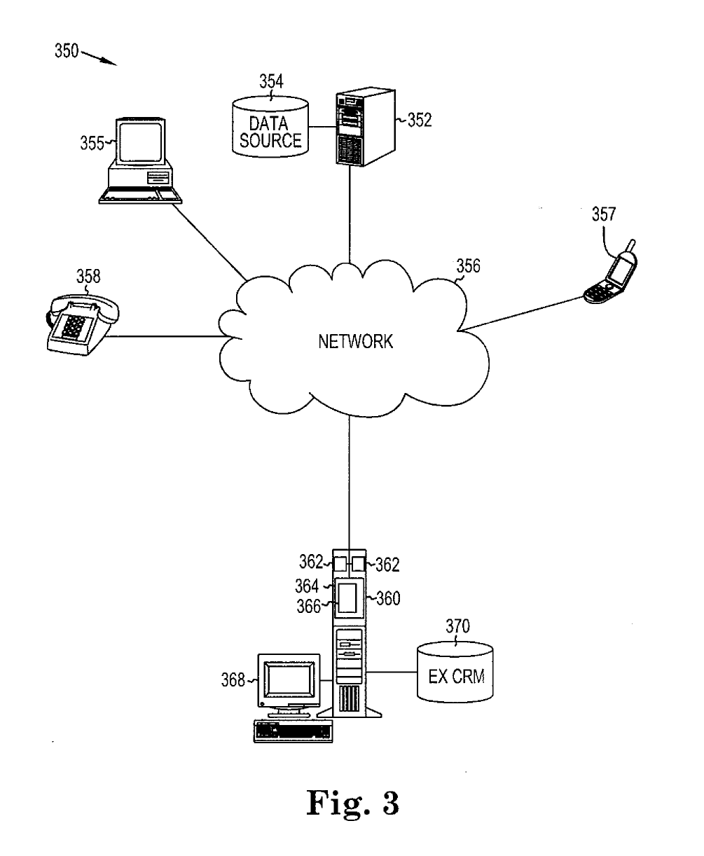

The reader will appreciate that the matching score of resource w for position ji can be obtained by various methods and/or systems, including those set forth by FIGS. 2 and 3 of the present disclosure, those described in U.S. Patent Application Serial No. PCT/US2008/081803, entitled, “Supply and Demand Consolidation in Employee Resource Planning,” filed on 30 Oct. 2008, and having the same Assignee, the contents of which are incorporated by reference in their entirety herein, and those described in U.S. Patent Application Serial No. 13045764, entitled, “Resource Skill Compliance Optimization,” having docket number 201005591 US01, filed on 11 Mar. 2011, and having the same Assignee, the contents of which are incorporated by reference in their entirety herein.

According to one or more example implementations of the present disclosure, the RP-FTE model 101, implemented as an MIP mathematical model for example, determines the following parameters:

$${K}_{w , t} = {\sum }_{τ = 1}^{t} Δ {K}_{w , t} \text{:}$$

Total FTE capacity of resource w during period t

FA={wεW, jiεJI:Q_{w,ji}=1 and REQ_{ji,t}>0}: Specifies a set of feasible allocations of resource w to position ji at period t. That is, the set of feasible allocations includes instances of a resource being qualified for a position where the requirements (e.g., skills, skill level) are non-zero (e.g., some skill and/or skill level required for the position).

$$F A T = {⋃}_{t ∈ T} FA ( w , ji ) \text{:}$$

Set of feasible allocations of employee w to position ji at any period t of planning T. The set FAT includes (e.g., union) of all sets FA for periods within the planning horizon T.

ε˜U(0.00001,0.0001): This is a perturbation of matching score. The perturbation is a small change that can be added to a value of a decision variable in order to test whether a solution is a unique solution, since more than one resource may be similarly qualified to perform a particular job. For example, the perturbation may be distributed as uniform distribution in the interval [0.00001, 0.0001]; however, other ranges are contemplated where a perturbation therein can accomplish similar testing. According to some example implementations, an optimal solution should be unique. Use of the perturbation can help avoid symmetrical solutions and improve speed of reaching an optimal solution.

GAPPNLTY_{ji,t}=(|T|−(t−1))*ppᵢ*RLⱼᵢ: A penalty for a gap at position ji during period t. Revenue can be lost if one or more positions of a project are not filled since a lack of resources can impact completion of the project. The penalty for a gap at position depends on the revenue loss associated with the particular position and the priority of the project to which the position is associated. The reader will appreciate that near term penalties (i.e., penalties in earlier time periods) can be greater than penalties in later time periods, for example, due to the time value of money and/or timing of disruption to other project activities.

According to one or more example implementations of the present disclosure, the RP-FTE model 101, implemented as an MIP mathematical model, can operate to evaluate the following decision variables:

x_{w,j,i,t}≧0: Indicates an amount of resource w capacity allocated to requirements of position ji during time t, expressed, for example, as a portion of total capacity requirements of a position. That is, x_{w,j,i,t} indicates the amount of a position requirement that has resources allocated thereto. A value of 0 indicates a resource is not allocated to position ji during time t, and a value of 1 indicates one or more resources are fully allocated to position ji during time t, for example.

u_{w,j,i}ε{0,1}: 1 iff (i.e., if and only if) resource w is allocated to position ji; 0 otherwise. This flag indicates whether resource w has some (i.e., non-zero) allocation to position ji (e.g., at some time t).

gap_{j,i,t}≧0: Gap for position ji during period t. A gap greater than zero indicates some portion of position ji is not satisfied during time t.

benefit: total benefit of allocation.

According to one or more example implementations of the present disclosure, the RP-FTE model 101, implemented as an MIP mathematical model for example, has as an objective function, to maximize total benefit associated with an arrangement of resource-position combinations. This can be accomplished by evaluating and comparing a maximum benefit associated with particular resource-position combinations according to the following equation:

$$Benefit = {\sum }_{( w , ji , t ) ∈ FA} ( {MS}_{w , ji} - {ɛ}_{w , ji} ) * {x}_{x , ji , t} - ( {\sum }_{( w , ji ) ∈ FAT} {CU}_{w , ji} * {u}_{w , ji} + {\sum }_{( ji , t ) : REQ ( ji , t ) > 0} {GAPPNLTY}_{ji , t} * {gap}_{ji , t} )$$

The summation involves the matching score of resource w with position ji for each combination of resource, position, and time period included in set FA (i.e., set of feasible allocations of resource w to position ji at period t). The reader will appreciate that the matching score is offset slightly by the perturbation, and that only those matching scores corresponding to a resource w and position ji during time t combination that has a non-zero amount of allocation of resource w capacity to requirements of position ji during time t will add to the benefit. From the equation above, it is understood that the allocation of fixed cost of resource w to position ji and the gap penalty (if any) associated with positions for which a resource is not been allocated are subtracted from the matching score totals associated with positions to which a resource has been allocated. It should be appreciated that the RP-FTE model 101, implemented as an MIP mathematical model for example, seeks to maximize the total allocation matching score and minimizing the total penalty of having gaps and total fixed penalty for allocation.

In seeking convergence to a solution that maximizes the total benefit according to the equation above, the RP-FTE model 101, implemented as an MIP mathematical model for example, is constrained to solutions that satisfy a demand constraint 106, a supply constraint 107, and a constancy constraint 108. That is, the solutions are subject to the following constraints:

1) Demand: Satisfy FTE requirements of position ji during period t

$${\sum }_{w ∈ FA ( ji , t )} {x}_{w , j , i , t} + {gap}_{j , i , t} = {REQ}_{j , i , t}$$

The FTE requirements of a position that are allocated to one or more resources plus the gap must equal the requirements of the position. Generally, the gap is set to reflect the difference between the position requirements and that portion satisfied by allocation of one or more resources in a given time period.

2) Supply: For each resource w and period t, satisfy the total FTE capacity available:

$${\sum }_{ji ∈ FA ( w , t )} {x}_{w , j , i , t} \leq {K}_{w , t}$$

Simply, the FTE capacity of resource w during period t allocated to one or more positions cannot exceed the total FTE capacity of resource w during period t.

3) Constancy: Ensure that same resource w capacity is allocated to same position ji over planning horizon.

$${\sum }_{t ∈ FAT ( w , ji )} {x}_{w , jt , t} = {u}_{w , ji} * {\sum }_{t ∈ FAT ( w , ji )} {REQ}_{j , i , t}$$

For example, if a particular resource is one of many available employees having an engineering skill, the constancy constraint ensures that a optimal solution should not be based a position in a project being filled by a different engineer each week, as doing so would be disruptive to the project, and thus, not optimal in practice.

The following example illustrates the RP-FTE model described above, particularly with respect to inputs and outputs. Consider a set of resources (e.g., employees) identified as follows:

W={nzw616, nzw695, nzw6bh, nzw6ch, nzw6lz, nzw6 m3, nzw6rm, nzw6rx}.

Set W includes 8 resources, the identifiers of each being listed above.

Also consider a set of 17 positions ji={job.project} defined in Table 1 as follows:

TABLE 1
Job.Project
601610.A
601611.A
600163.A
601609.A
601632.A
598496.A
600883.A
601682.A
601681.A
599901.A
599902.A
601633.A
601680.A
601631.A
601873.A
598699.A
598499.A

Table 1 shows a position identifier comprising a job identifier and a project identifier. While the job identifier and project identifiers are shown delimited by a decimal point in the Table 1, any data arrangement and/or concatination convention may be used to implement the methods of the present disclosure. The reader will appreciate that for this example, all of the jobs are all associated with Project A.

A planning horizon is defined by the following set of periods:

T={201001t0, 201001t1, 201001t2, 201001t3}

The set T includes 4 time periods. The period identifiers of this example convey the year, month and week of the respective time period. For example, 201001t0 indicates the year of 2010 (first four digits), first month (digits 5 and 6), and week 0 (digit after separater t).

The following Table 2 defines the FTE requirements at each period in the planning horizon. Each position identifier is in the form of job.project.time-period. The FTE required corresponding to each position specifies the input parameter REQ_{j,i,t}.

TABLE 2

| Positions | FTE | Positions | FTE - |
|---|---|---|---|
| (job.project.time) | required | (job.project.time) | required |
| 601610.A.201002t0 | 0.06 | 600883.A.201002t0 | 0.18 |
| 601610.A.201002t1 | 0.06 | 600883.A.201002t1 | 0.18 |
| 601610.A.201002t2 | 0.06 | 600883.A.201002t2 | 0.18 |
| 601610.A.201002t3 | 0.06 | 600883.A.201002t3 | 0.18 |
| 601611.A.201002t0 | 0.09 | 601682.A.201002t0 | 0.3 |
| 601611.A.201002t1 | 0.09 | 601682.A.201002t1 | 0.3 |
| 601611.A.201002t2 | 0.09 | 601682.A.201002t2 | 0.3 |
| 601611.A.201002t3 | 0.09 | 601682.A.201002t3 | 0.3 |
| 600163.A.201002t0 | 0.3 | 601681.A.201002t0 | 0.2 |
| 600163.A.201002t1 | 0.3 | 601681.A.201002t1 | 0.2 |
| 600163.A.201002t2 | 0.3 | 601681.A.201002t2 | 0.2 |
| 600163.A.201002t3 | 0.3 | 601681.A.201002t3 | 0.2 |
| 601609.A.201002t0 | 0.06 | 599901.A.201002t0 | 0.2 |
| 601609.A.201002t1 | 0.06 | 599901.A.201002t1 | 0.2 |
| 601609.A.201002t2 | 0.06 | 599901.A.201002t2 | 0.2 |
| 601609.A.201002t3 | 0.06 | 599901.A.201002t3 | 0.2 |
| 601632.A.201002t0 | 0.2 | 599902.A.201002t0 | 0.2 |
| 601632.A.201002t1 | 0.2 | 599902.A.201002t1 | 0.2 |
| 601632.A.201002t2 | 0.2 | 599902.A.201002t2 | 0.2 |
| 601632.A.201002t3 | 0.2 | 599902.A.201002t3 | 0.2 |
| 598496.A.201002t0 | 1 | 601633.A.201002t0 | 0.3 |
| 598496.A.201002t1 | 1 | 601633.A.201002t1 | 0.3 |
| 598496.A.201002t2 | 1 | 601633.A.201002t2 | 0.3 |
| 598496.A.201002t3 | 1 | 601633.A.201002t3 | 0.3 |
| | | 601680.A.201002t0 | 0.2 |

The following Table 3 defines the resource capacity available at each period during the planning horizon. Each resource identifier is in the form of resource.time-period. The FTE required corresponding to each resource identifier specifies the input parameter ΔK_{w,t} for the time period.

TABLE 3

| Resource | FTE - |
|---|---|
| capacity | available |
| nzw616.201002t0 | 0.02 |
| nzw695.201002t0 | 1 |
| nzw6bh.201002t0 | 1 |
| nzw6ch.201002t0 | 1 |
| nzw6lz.201002t0 | 1 |
| nzw6m3.201002t0 | 0.05 |
| nzw6rm.201002t0 | 1 |
| nzw6rx.201002t0 | 0.05 |

The following Table 4 indicates resource qualifications with respect to each of the 17 positions. That is, Table 4 shows whether a resource w is qualified for a position ji and provides the associated matching score. Each resource-position identifier is in the form of resource.position, where position is specified as job.time-period. Table 4 relates to input parameters Q_{w,j,i} and MS_{w,j,i}. As the matching score of each resource with respect to each position is 1, each resource is fully qualified to fill any position. Therefore, Q_{w,j,i} is also 1 for each resource-position combination shown in Table 4.

| Resource-position | Matching | Resource.position | Matching |
|---|---|---|---|
| qualification | score | qualification | score |
| nzw616.598496.A | 1 | nzw6bh.598496.A | 1 |
| nzw616.598499.A | 1 | nzw6bh.598499.A | 1 |
| nzw616.598699.A | 1 | nzw6bh.598699.A | 1 |
| nzw616.599901.A | 1 | nzw6bh.599901.A | 1 |
| nzw616.599902.A | 1 | nzw6bh.599902.A | 1 |
| nzw616.600163.A | 1 | nzw6bh.600163.A | 1 |
| nzw616.600883.A | 1 | nzw6bh.600883.A | 1 |
| nzw616.601609.A | 1 | nzw6bh.601609.A | 1 |
| nzw616.601610.A | 1 | nzw6bh.601610.A | 1 |
| nzw616.601611.A | 1 | nzw6bh.601611.A | 1 |
| nzw616.601631.A | 1 | nzw6bh.601631.A | 1 |
| nzw616.601632.A | 1 | nzw6bh.601632.A | 1 |
| nzw616.601633.A | 1 | nzw6bh.601633.A | 1 |
| nzw616.601680.A | 1 | nzw6bh.601680.A | 1 |
| nzw616.601681.A | 1 | nzw6bh.601681.A | 1 |
| nzw616.601682.A | 1 | nzw6bh.601682.A | 1 |
| nzw616.601873.A | 1 | nzw6bh.601873.A | 1 |
| nzw695.598496.A | 1 | nzw6ch.598496.A | 1 |
| nzw695.598499.A | 1 | nzw6ch.598499.A | 1 |
| nzw695.598699.A | 1 | nzw6ch.598699.A | 1 |
| nzw695.599901.A | 1 | nzw6ch.599901.A | 1 |
| nzw695.599902.A | 1 | nzw6ch.599902.A | 1 |
| nzw695.600163.A | 1 | nzw6ch.600163.A | 1 |
| nzw695.600883.A | 1 | nzw6ch.600883.A | 1 |
| nzw695.601609.A | 1 | nzw6ch.601609.A | 1 |
| nzw695.601610.A | 1 | nzw6ch.601610.A | 1 |
| nzw695.601611.A | 1 | nzw6ch.601611.A | 1 |
| nzw695.601631.A | 1 | nzw6ch.601631.A | 1 |
| nzw695.601632.A | 1 | nzw6ch.601632.A | 1 |
| nzw695.601633.A | 1 | nzw6ch.601633.A | 1 |
| nzw695.601680.A | 1 | nzw6ch.601680.A | 1 |
| nzw695.601681.A | 1 | nzw6ch.601681.A | 1 |
| nzw695.601682.A | 1 | nzw6ch.601682.A | 1 |
| nzw695.601873.A | 1 | nzw6ch.601873.A | 1 |
| nzw6lz.598496.A | 1 | nzw6rm.598496.A | 1 |
| nzw6lz.598499.A | 1 | nzw6rm.598499.A | 1 |
| nzw6lz.598699.A | 1 | nzw6rm.598699.A | 1 |
| nzw6lz.599901.A | 1 | nzw6rm.599901.A | 1 |
| nzw6lz.599902.A | 1 | nzw6rm.599902.A | 1 |
| nzw6lz.600163.A | 1 | nzw6rm.600163.A | 1 |
| nzw6lz.600883.A | 1 | nzw6rm.600883.A | 1 |
| nzw6lz.601609.A | 1 | nzw6rm.601609.A | 1 |
| nzw6lz.601610.A | 1 | nzw6rm.601610.A | 1 |
| nzw6lz.601611.A | 1 | nzw6rm.601611.A | 1 |
| nzw6lz.601631.A | 1 | nzw6rm.601631.A | 1 |
| nzw6lz.601632.A | 1 | nzw6rm.601632.A | 1 |
| nzw6lz.601633.A | 1 | nzw6rm.601633.A | 1 |
| nzw6lz.601680.A | 1 | nzw6rm.601680.A | 1 |
| nzw6lz.601681.A | 1 | nzw6rm.601681.A | 1 |
| nzw6lz.601682.A | 1 | nzw6rm.601682.A | 1 |
| nzw6lz.601873.A | 1 | nzw6rm.601873.A | 1 |
| nzw6m3.598496.A | 1 | nzw6rx.598496.A | 1 |
| nzw6m3.598499.A | 1 | nzw6rx.598499.A | 1 |
| nzw6m3.598699.A | 1 | nzw6rx.598699.A | 1 |
| nzw6m3.599901.A | 1 | nzw6rx.599901.A | 1 |
| nzw6m3.599902.A | 1 | nzw6rx.599902.A | 1 |
| nzw6m3.600163.A | 1 | nzw6rx.600163.A | 1 |
| nzw6m3.600883.A | 1 | nzw6rx.600883.A | 1 |
| nzw6m3.601609.A | 1 | nzw6rx.601609.A | 1 |
| nzw6m3.601610.A | 1 | nzw6rx.601610.A | 1 |
| nzw6m3.601611.A | 1 | nzw6rx.601611.A | 1 |
| nzw6m3.601631.A | 1 | nzw6rx.601631.A | 1 |
| nzw6m3.601632.A | 1 | nzw6rx.601632.A | 1 |
| nzw6m3.601633.A | 1 | nzw6rx.601633.A | 1 |
| nzw6m3.601680.A | 1 | nzw6rx.601680.A | 1 |
| nzw6m3.601681.A | 1 | nzw6rx.601681.A | 1 |
| nzw6m3.601682.A | 1 | nzw6rx.601682.A | 1 |
| nzw6m3.601873.A | 1 | nzw6rx.601873.A | 1 |

The priority of Project A of this example is 100. The Revenue loss of position ji is RLⱼᵢ=1000 for all positions ji. The allocation fixed cost of employee w to position ji is CU_{w,j,i}=100.

Using the above-described input parameters, the RP-FTE model 101, implemented as an MIP mathematical model for example, generates the following optimal allocation table. FTE requirements are indicated by “Req,” gaps are indicated by “Gap,” and resource allocations are indicated by the resource ID. For example, the FTE requirements of position 601610.A (e.g., job 601610 of project A) corresponding to each time period are provided in the first row of the table. However, the optimal solution does not allocate a resource to position 601610.A; therefore, a gap equivalent to the position FTE requirements occurs, as shown in the second row of the table. The reader will appreciate that while 17 positions were available for staffing in this example, only 8 resources are available to fill the 17 positions. Furthermore, some of the positions have less than full time FTE requirements in a period, so that a resource might be capable of satisfying more than one position in a given period (e.g., via part time in allocation to multiple positions). Therefore, a solution with gaps is to be expected in this scenario until new resources can be procured.

The requirements of position 600163.A (e.g., job 600163 of project A) corresponding to each time period are provided in the fifth row of the table. The optimal solution allocates resource nzw695 to position 600163.A as indicated in the sixth row of the table. Therefore the gap associated with position 600163.A is zero (shown in seventh row of table) since resource nzw695 satisfies the requirements of position 600163.A. It should be noted that the resource allocation is consistent over time, which is the result of the ε perturbation in the matching score, the fixed allocation cost CU_{w,j,i}, and the constancy constraint in the RP-FTE model 101, implemented as an MIP mathematical model.

The table below also shows resource nzw695 also satisfies the FTE requirements of positions 601632, 601682, and 601680.

TABLE 5

| | Job | Project | | | | |
|---|---|---|---|---|---|---|
| | (j index) | (i index) | 201002t0 | 201002t1 | 201002t2 | 201002t3 |
| Req | 601610 | A | 0.06 | 0.06 | 0.06 | 0.06 |
| Gap | 601610 | A | 0.06 | 0.06 | 0.06 | 0.06 |
| Req | 601611 | A | 0.09 | 0.09 | 0.09 | 0.09 |
| Gap | 601611 | A | 0.09 | 0.09 | 0.09 | 0.09 |
| Req | 600163 | A | 0.3 | 0.3 | 0.3 | 0.3 |
| nzw695 | 600163 | A | 0.3 | 0.3 | 0.3 | 0.3 |
| Gap | 600163 | A | 0 | 0 | 0 | 0 |
| Req | 601609 | A | 0.06 | 0.06 | 0.06 | 0.06 |
| Gap | 601609 | A | 0.06 | 0.06 | 0.06 | 0.06 |
| Req | 601632 | A | 0.2 | 0.2 | 0.2 | 0.2 |
| nzw695 | 601632 | A | 0.2 | 0.2 | 0.2 | 0.2 |
| Gap | 601632 | A | 0 | 0 | 0 | 0 |
| Req | 598496 | A | 1 | 1 | 1 | 1 |
| nzw6bh | 598496 | A | 1 | 1 | 1 | 1 |
| Gap | 598496 | A | 0 | 0 | 0 | 0 |
| Req | 600883 | A | 0.18 | 0.18 | 0.18 | 0.18 |
| Gap | 600883 | A | 0.18 | 0.18 | 0.18 | 0.18 |
| Req | 601682 | A | 0.3 | 0.3 | 0.3 | 0.3 |
| nzw695 | 601682 | A | 0.3 | 0.3 | 0.3 | 0.3 |
| Gap | 601682 | A | 0 | 0 | 0 | 0 |
| Req | 601681 | A | 0.2 | 0.2 | 0.2 | 0.2 |
| Gap | 601681 | A | 0.2 | 0.2 | 0.2 | 0.2 |
| Req | 599901 | A | 0.2 | 0.2 | 0.2 | 0.2 |
| Gap | 599901 | A | 0.2 | 0.2 | 0.2 | 0.2 |
| Req | 599902 | A | 0.2 | 0.2 | 0.2 | 0.2 |
| Gap | 599902 | A | 0.2 | 0.2 | 0.2 | 0.2 |
| Req | 601633 | A | 0.3 | 0.3 | 0.3 | 0.3 |
| nzw616 | 601633 | A | 0.02 | 0.02 | 0.02 | 0.02 |
| Gap | 601633 | A | 0.28 | 0.28 | 0.28 | 0.28 |
| Req | 601680 | A | 0.2 | 0.2 | 0.2 | 0.2 |
| nzw695 | 601680 | A | 0.2 | 0.2 | 0.2 | 0.2 |
| Gap | 601680 | A | 0 | 0 | 0 | 0 |
| Req | 601631 | A | 0.2 | 0.2 | 0.2 | 0.2 |
| nzw6m3 | 601631 | A | 0.05 | 0.05 | 0.05 | 0.05 |
| nzw6rx | 601631 | A | 0.05 | 0.05 | 0.05 | 0.05 |
| Gap | 601631 | A | 0.1 | 0.1 | 0.1 | 0.1 |
| Req | 601873 | A | 1 | 1 | 1 | 1 |
| nzw6ch | 601873 | A | 1 | 1 | 1 | 1 |
| Gap | 601873 | A | 0 | 0 | 0 | 0 |
| Req | 598699 | A | 1 | 1 | 1 | 1 |
| nzw6lz | 598699 | A | 1 | 1 | 1 | 1 |
| Gap | 598699 | A | 0 | 0 | 0 | 0 |
| Req | 598499 | A | 1 | 1 | 1 | 1 |
| nzw6rm | 598499 | A | 1 | 1 | 1 | 1 |
| Gap | 598499 | A | 0 | 0 | 0 | 0 |

The RP-FTE model 101, implemented as an MIP mathematical model, may also generate the following Table 6 which defines the optimal resource capacity consumption summarized by resource. The first line corresponding to each resource (without a job and project designated) provides the capacity of the resource. For example as described above, a portion of resource nzw695 is allocated to each of positions 600163.A, 601632.A, 601682.A, and 601680.A, equal to the respective requirements of the positions. The sum of the allocation to positions for each allocated resource is equal to the capacity of the resource in this example.

TABLE 6

| Resource | Job | Project | 201002t0 | 201002t1 | 201002t2 | 201002t3 |
|---|---|---|---|---|---|---|
| nzw616 | | | 0.02 | 0.02 | 0.02 | 0.02 |
| nzw616 | 601633 | A | 0.02 | 0.02 | 0.02 | 0.02 |
| nzw695 | | | 1 | 1 | 1 | 1 |
| nzw695 | 600163 | A | 0.3 | 0.3 | 0.3 | 0.3 |
| nzw695 | 601632 | A | 0.2 | 0.2 | 0.2 | 0.2 |
| nzw695 | 601682 | A | 0.3 | 0.3 | 0.3 | 0.3 |
| nzw695 | 601680 | A | 0.2 | 0.2 | 0.2 | 0.2 |
| nzw6bh | | | 1 | 1 | 1 | 1 |
| nzw6bh | 598496 | A | 1 | 1 | 1 | 1 |
| nzw6ch | | | 1 | 1 | 1 | 1 |
| nzw6ch | 601873 | A | 1 | 1 | 1 | 1 |
| nzw6lz | | | 1 | 1 | 1 | 1 |
| nzw6lz | 598699 | A | 1 | 1 | 1 | 1 |
| nzw6m3 | | | 0.05 | 0.05 | 0.05 | 0.05 |
| nzw6m3 | 601631 | A | 0.05 | 0.05 | 0.05 | 0.05 |
| nzw6rm | | | 1 | 1 | 1 | 1 |
| nzw6rm | 598499 | A | 1 | 1 | 1 | 1 |
| nzw6rx | | | 0.05 | 0.05 | 0.05 | 0.05 |
| nzw6rx | 601631 | A | 0.05 | 0.05 | 0.05 | 0.05 |

FIG. 2 illustrates an example resource planning system according to the present disclosure. FIG. 2 illustrates a resource planning system using full time equivalents (FTE) 201, according to an example implementation. The resource planning system using FTE 201 may be implemented in software, hardware or a combination of hardware and software. The resource planning system using FTE 201 may be software stored on a non-transient computer readable storage device, and executed by a computer system.

The resource planning system using FTE 201 includes a resource planning tool 220 that includes a scoring and compliance mechanism 222 and a matching engine 224. The matching engine can include logic to maximize a total benefit by maximizing a total matching score and minimizing a total penalty associated with having gaps and allocation of fixed costs of allocated resources, subject to demand, supply, and constancy constraints, as described with respect to FIG. 1. Maximizing a total matching score can include maximizing organization compliance 226, as described in U.S. patent application Ser. No. 13/045,764, entitled, “Resource Skill Compliance Optimization,” having docket number 201005591US01, filed on 11 Mar. 2011, and incorporated by reference herein, or as described in U.S. Patent Application Serial No. PCT/US2008/081803, entitled, “Supply and Demand Consolidation in Employee Resource Planning,” filed on 30 Oct. 2008, and having the same Assignee, the contents of which are incorporated by reference in their entirety herein. The matching engine 224 may be implemented using a mixed integer programming model. Alternatively, an RP-FTE model of the present disclosure can be implemented to optimize a total matching score and mitigate a total penalty. Optimizing will be appreciated as including maximum and near-maximum values, intending to obtain an efficient solution, such as a solution that exceeds a pre-defined threshold of performance. Similarly, mitigate will be appreciated as including minimum and near-minimum values, intending to obtain an efficient solution, such as a solution having a penalty value that does not exceed a pre-defined threshold.

The planning tool 220 is connected to a jobs database 232, a resource attributes database 234, and a projects database 236. The jobs database 232 stores attributes for each job, and can include a job identifier 232A, information regarding one or more job skills 234B associated with a respective job, information regarding a skill weight 232C associated with a respective job skill 232B, and time period information 232D. The information regarding the one or more job skills can identify the skill and a skill level required by a respective job. The time period information 232D can specify the FTE job requirements corresponding to a particular time periods.

The resource attributes database 234 stores resource attributes for each resource, and can include a resource identifier 234A, information regarding one or more resource skills 234B associated with a respective resource, and time period information 234C. The information regarding the one or more resource skills can identify the skill and skill level associated with a respective resource. For example, the qualifications of each candidate for a job, which may be taken from a resume, are entered in the resource attributes database 234 as resource attributes. The time period information 234C can specify the extent to which a particular resource is available in corresponding time periods, expressed as FTEs, for example.

The projects database 236 stores project attributes for each project, and can include a project identifier 236A, project priority information 236B, jobs information 236C, and time period information 236D. For example, the FTE job requirements and their corresponding qualifications needed for a new project may be specified as part of the project design/planning, and entered into the projects database. The jobs information 236C can specify the project requirements (e.g., information regarding one or more jobs associated with a respective project expressed as FTEs), and the time period information 236D can provide information corresponding the FTE jobs to a particular time periods.

For one or more time periods, the scoring and compliance mechanism 222 determines a matching score, such as by determining an individual skill compliance, for each skill of each resource with respect to each skill of each job based on the resource skill level relative to the job skill level. For example, the scoring and compliance mechanism 222 can calculate employee skill compliance, for example, using FTEs. The scoring and compliance mechanism 222 can also operate to disqualify over-qualified resources.

The matching engine 224 can operate to determine resource skill compliance for each FTE resource with respect to each FTE job, for example, as a total of the individual skill level compliances for each skill corresponding to each job, and assign FTE resources to FTE jobs in a manner that optimizes a total of the resource skill compliances for those FTE resources assigned to FTE jobs. This can be accomplished using units of FTE for each of jobs and resources, among others. The planning tool 220 may output individual skill compliance 238 for combinations of resource (e.g., employee), project, job, and/or skill based on respective FTEs of each.

The planning tool 220 may also output job (e.g., position) compliance 240, where the jobs are expressed as FTEs, with or without position and project weighting, project, job, and/or skill. The planning tool 220 may also output resource skill compliance 242 to indicate a solution for assigning a particular FTE resource (e.g., employee) to a particular FTE job (e.g., position). The resource skill compliance output 242 can include a measure of organizational compliance (maximum or average per resource-job match where resources and jobs are expressed as FTEs).

FIG. 3 illustrates a block diagram of an example of a computing system for resource planning using full time equivalents according to the present disclosure. The computing system 350 comprises a number of computing resources communicatively coupled to the network 356. FIG. 3 shows a first computing device 352 that may also have an associated data source 354, and may have one or more input/output devices (e.g., keyboard, electronic display). A second computing device 360 is also shown in FIG. 3 being communicatively coupled to the network 356, such that executable instructions may be communicated through the network between the first and second computing devices.

Second computing device 360 may include one or more processors 362 communicatively coupled to a non-transitory computer-readable medium 364. The non-transitory computer-readable medium 364 may be structured to store executable instructions 366 (e.g., one or more programs) that can be executed by the one or more processors 362 and/or data. The second computing device 360 may be further communicatively coupled to a production device 368 (e.g., electronic display, printer, etc.). Second computing device 360 can also be communicatively coupled to an external computer-readable memory 370.

The second computing device 360 can cause an output to the production device 368, for example, as a result of executing instructions of one or more programs stored non-transitory computer-readable medium 364, by the at least one processor 362, to implement a system for resource skill compliance optimization according to the present disclosure. Causing an output can include, but is not limited to, displaying text and images to an electronic display and/or printing text and images to a tangible medium (e.g., paper). Executable instructions to determine resource planning using FTEs may be executed by the first 352 and/or second 360 computing device, stored in a database such as may be maintained in external computer-readable memory 370, output to production device 368, and/or printed to a tangible medium.

One or more computers 355 (e.g., customer-owned computers), telephones 358, and/or portable communication devices 357, used to communicate with a system for resource skill compliance optimization, may also be communicatively coupled to the network 356. Computers 355, telephones 358, and/or portable communication devices 357 may be communicatively coupled to the network 356 via a communication link that includes a wireless portion. The telephones 358 and/or portable communication devices 357 may be computing devices, and/or may include processing resources.

First 352 and second 360 computing devices are communicatively coupled to one another through the network 356. While the computing system is shown in FIG. 3 having only two computing devices, the computing system can be comprised of additional multiple interconnected computing devices, such as server devices and/or clients. Each computing device can include control circuitry such as a processor, a state machine, application specific integrated circuit (ASIC), controller, and/or similar machine. As used herein, the indefinite articles “a” and/or “an” can indicate one or more than one of the named object. Thus, for example, “a processor” can include one processor or more than one processor, such as a parallel processing arrangement.

The control circuitry can have a structure that provides a given functionality, and/or execute computer-readable instructions that are stored on a non-transitory computer-readable medium (e.g., 354, 364, 370). The non-transitory computer-readable medium can be integral (e.g., 364), or communicatively coupled (e.g., 354, 370), to the respective computing device (e.g. 352, 360), in either in a wired or wireless manner. For example, the non-transitory computer-readable medium can be an internal memory, a portable memory, a portable disk, or a memory located internal to another computing resource (e.g., enabling the computer-readable instructions to be downloaded over the Internet). The non-transitory computer-readable medium (e.g., 354, 364, 370) can have computer-readable instructions stored thereon that are executed by the control circuitry (e.g., processor) to provide a particular functionality (e.g., resource planning using FTEs).

The non-transitory computer-readable medium, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), among others. The non-transitory computer-readable medium can include optical discs, digital video discs (DVD), high definition digital versatile discs (HD DVD), compact discs (CD), laser discs, and magnetic media such as tape drives, floppy discs, and hard drives, solid state media such as flash memory, EEPROM, phase change random access memory (PCRAM), as well as other types of machine-readable media.

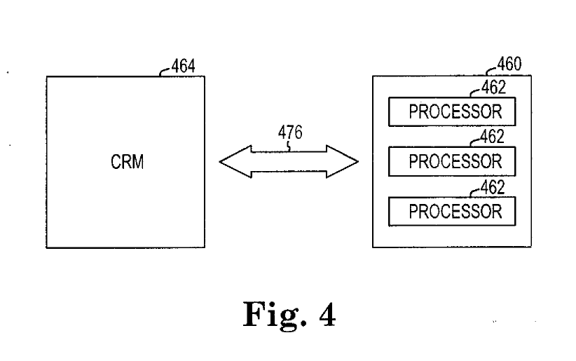

FIG. 4 illustrates a block diagram of an example of a computer readable medium (CRM) 464 in communication with processing resources 460 according to the present disclosure. As used herein, processor resources 460 can include one or a plurality of processors 462 such as in a parallel processing arrangement. A computing device having processor resources can be in communication with, and/or receive a tangible non-transitory computer readable medium (CRM) 464 storing a set of computer readable instructions (e.g., software) for capturing and/or replaying network traffic, as described herein.

As used herein, the indefinite articles “a” and/or “an” can indicate one or more than one of the named object. Thus, for example, “a processor” can include one processor or more than one processor. Processor resources can be also be control circuitry that can have a structure that provides a given functionality, and/or execute computer-readable instructions that are stored on an internal or external non-transitory computer-readable medium.

Non-transitory computer-readable medium (e.g., 464), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), high definition digital versatile discs (HD DVD), compact discs (CD), and/or a solid state drive (SSD), flash memory, etc., as well as other types of machine-readable media.

The non-transitory computer-readable medium can be integral, or communicatively coupled, to a computing device, in either in a wired or wireless manner. For example, the non-transitory computer-readable medium can be an internal memory, a portable memory, a portable disk, or a memory located internal to another computing resource (e.g., enabling the computer-readable instructions to be downloaded over the Internet). The non-transitory computer-readable medium can have computer-readable instructions stored thereon that are executed by the processing resources (e.g., control circuitry, processor(s)) to provide a particular functionality (e.g., resource planning using FTEs). The CRM 464 can be in communication with the processing resources 460 via a communication path 476. The communication path 476 can be local or remote to a machine associated with the processing resources 460.

In other examples, the communication path 476 can be such that the CRM 464 is remote from the processing resources 460 such as in the example of a network connection between the CRM 464 and the processing resources 460 (e.g., the communication path 476 can be a network connection). Examples of such a network connection can include a local area network (LAN), a wide area network (WAN), a personal area network (PAN), the Internet, among others. In such examples, the CRM 464 may be associated with a first computing device (e.g., a server) and the processing resources 460 may be associated with a second computing device (e.g., a client). The first and second computers can be in communication via a networked communication path 476.

Logic can be used to implement the method(s) of the present disclosure, in whole or part. Logic can be implemented using appropriately configured hardware and/or software. The above-mention logic portions may be discretely implemented and/or implemented in a common arrangement.

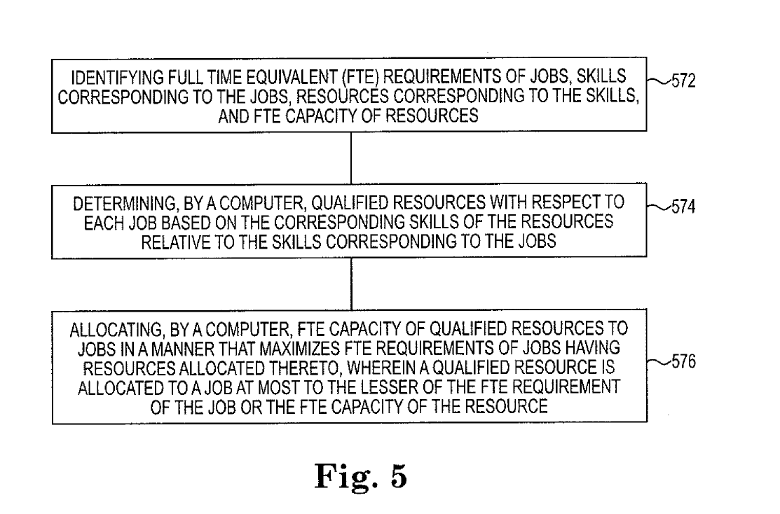

FIG. 5 is a flow chart illustrating an example of a method for resource planning using FTEs according to the present disclosure. The method includes identifying full time equivalent (FTE) requirements of jobs, skills corresponding to the jobs, resources corresponding to the skills, and FTE capacity of resources, as shown at 572. Qualified resources are determined at 574, by a computer, with respect to each job based on the corresponding skills of the resources relative to the skills corresponding to the jobs. As indicated at 576, FTE capacity of qualified resources is allocated, by a computer, to jobs in a manner that maximizes FTE requirements of jobs having resources allocated thereto, such that a qualified resource is allocated to a job at most to the lesser of the FTE requirement of the job or the FTE capacity of the resource.

The above specification, including examples and data, provide a description of the method, applications, and use of the system and method of the present disclosure. Since many examples can be made without departing from the spirit and scope of the system and method of the present disclosure, this specification merely sets forth some of the many possible example implementation configurations and implementations. Some features are grouped together in a single example implementation for the purpose of streamlining the disclosure. This method of disclosure is not to be interpreted as reflecting an intention that the disclosed examples of the present disclosure have to use more features than are expressly recited in each claim. Inventive subject matter lies in less than all features of a single disclosed example implementation. Thus, the following claims are hereby incorporated into the Detailed Description, with each claim standing on its own as a separate example implementation.

Although specific examples have been illustrated and described herein, those of ordinary skill in the art will appreciate that an arrangement calculated to achieve the same results can be substituted for the specific examples shown. It is to be understood that the above description has been made in an illustrative fashion, and not a restrictive one. Examples set forth in this specification are not intended to be limiting and merely set forth some of the many possible examples for the claimed system and method for resource skill compliance optimization.

In the foregoing discussion of the present disclosure, reference is made to the accompanying drawings that form a part hereof, and in which is shown by way of illustration how examples of the disclosure may be practiced. It is to be understood that other examples may be utilized and that process, electrical, and/or structural changes may be made without departing from the scope of the present disclosure. The figures attempt to follow a numbering convention in which the first digit corresponds to the drawing figure number and the remaining digits identify an element or component in the drawing. Similar elements or components between different figures may be identified by the use of similar digits. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

What is claimed:

1. A method for resource planning, comprising:
identifying full time equivalent (FTE) requirements of jobs, skills corresponding to the jobs, resources corresponding to the skills, and FTE capacity of resources;
determining, by a computer, qualified resources with respect to each job based on the corresponding skills of the resources relative to the skills corresponding to the jobs; and
allocating, by a computer, FTE capacity of qualified resources to jobs in a manner that maximizes FTE requirements of jobs having resources allocated thereto,
wherein a qualified resource is allocated to a job at most to the lesser of the FTE requirement of the job or the FTE capacity of the resource.

2. The method as set forth in claim 1, wherein the FTE requirements of jobs and the FTE capacity of resources are defined for each of multiple time periods.

3. The method as set forth in claim 2, further includes evaluating a constancy constraint determined from the FTE requirements of jobs and the FTE capacity of resources, wherein the constancy constraint favors a particular FTE capacity of a qualified resource being allocated to a same particular FTE requirement of a job over multiple time periods.

4. The method as set forth in claim 1, wherein allocating FTE capacity of qualified resources to jobs in a manner that maximizes FTE requirements of jobs having resources allocated thereto includes testing a perturbation for each resource-job match.

5. The method as set forth in claim 1, further including determining a gap corresponding to a job, wherein the gap indicates a portion of the FTE requirements of the job to which an FTE capacity of a resource is not allocated.

6. The method as set forth in claim 1, wherein allocating FTE capacity of qualified resources to jobs includes minimizing an economic penalty associated with FTE requirements of the jobs to which an FTE capacity of a resource is not allocated.

7. The method as set forth in claim 6, further including identifying jobs corresponding to one or more projects, and identifying a priority associated with individual ones of the one or more projects, wherein the economic penalty associated with FTE requirements of a particular job is adjusted by the priority associated with a project to which the job corresponds.

8. The method as set forth in claim 7, wherein the economic penalty is further adjusted to account for the time value of money based on a time period during which the FTE requirements of a job are associated.

9. The method as set forth in claim 1, wherein allocating FTE capacity of qualified resources to jobs includes minimizing an allocation of fixed cost of resources for the FTE capacity of qualified resources allocated to jobs.

10. The method as set forth in claim 1, wherein allocating FTE capacity of qualified resources to jobs includes allocating at least some FTE capacity of a particular qualified resource to a plurality of jobs.

11. The method as set forth in claim 1, wherein allocating FTE capacity of qualified resources to jobs includes allocating at least some FTE capacity of a plurality of qualified resources to a particular job.

12. A non-transitory computer-readable medium having computer-readable instructions stored thereon that, if executed by one or more processors, cause the one or more processors to:
identify full time equivalent (FTE) requirements of jobs, skills corresponding to the jobs, resources corresponding to the skills, and FTE capacity of resources;
determine qualified resources with respect to each job based on the corresponding skills of the resources relative to the skills corresponding to the jobs; and
allocate FTE capacity of qualified resources to jobs in a manner that maximizes FTE requirements of jobs having resources allocated thereto,
wherein a qualified resource is allocated to a job at most to the lesser of the FTE requirement of the job or the FTE capacity of the resource, and
wherein the FTE requirements of jobs and the FTE capacity of resources are defined for each of multiple time periods.

13. The non-transitory computer-readable medium of claim 12, further having computer-readable instructions stored thereon that, if executed by one or more processors, cause the one or more processors to allocate FTE capacity of a particular qualified resource to a same job for each of the multiple time periods.

14. The non-transitory computer-readable medium of claim 12, further having computer-readable instructions stored thereon that, if executed by one or more processors, cause the one or more processors to allocate less than all FTE capacity of a particular qualified resource to each of a plurality of jobs.

15. A system for resource planning, comprising:
a memory operable to store executable instructions; and
a processor coupled to the memory, wherein the processor executes the instructions to:
identify full time equivalent (FTE) requirements of jobs, skills corresponding to the jobs, resources corresponding to the skills, and FTE capacity of resources;
determine qualified resources with respect to each job based on the corresponding skills of the resources relative to the skills corresponding to the jobs; and
allocate FTE capacity of qualified resources to jobs in a manner that maximizes FTE requirements of jobs having resources allocated thereto,
wherein a qualified resource is allocated to a job at most to the lesser of the FTE requirement of the job or the FTE capacity of the resource, and
wherein the FTE requirements of jobs and the FTE capacity of resources are defined for each of multiple time periods.
